(19) United States
(12) Patent Application Publication
(10) Pub. No.: US 2016/0377170 A1
(43) Pub. Date: Dec. 29, 2016

(54) AXIAL SECURING OF A PLANETARY GEARING BEARING ARRANGEMENT

(71) Applicants: ZF Friedrichshafen AG, Friedrichshafen (DE); ZF WIND POWER ANTWERPEN N.V., Lommel (BE)

(72) Inventor: Dirk LEIMANN, Edegem (BE)

(21) Appl. No.: 15/038,822

(22) PCT Filed: Nov. 18, 2014
(86) PCT No.: PCT/EP2014/074823

§ 371 Date: May 24, 2016

(30) Foreign Application Priority Data
Dec. 18, 2013 (DE) 102013226520.4

(51) Int. Cl. F16H 57/08; F03D 80/70; F16H 1/28

(52) U.S. Cl. CPC F16H 57/082; F16H 1/28; F03D 80/70; F16H 2057/085; F05B 2260/40311

(57) ABSTRACT

A planetary transmission, for a wind turbine, having at least one of each of a planetary gearwheel, a shaft and a carrier. The planetary gearwheel is mounted by at least first and second bearings for rotation on the shaft. The first bearing supports the gearwheel against displacement in a first axial direction while the second bearing supports the gearwheel against displacement in a second axial direction, opposite to the first direction. The planetary transmission includes elements for supporting inner rings of the first and the second bearings against respective displacement in the first and the second directions, and an element for supporting the shaft on the carrier against displacement of the shaft in the first direction. The elements for supporting the shaft on the carrier are arranged so that the first and the second bearings cannot be in a load path between the planetary shaft and the carrier.

This application is a National Stage completion of PCT/EP2014/074823 filed Nov. 18, 2014, which claims priority from German patent application serial no. 10 2013 226 520A filed Dec. 18. 2013.

### FIELD OF THE INVENTION

The present invention concerns a planetary transmission, which can be used in particular as a planetary stage in the transmission of a wind turbine.

### BACKGROUND OF THE INVENTION

FIG. 1 shows a bearing of a planetary gearwheel 102 in a planetary transmission of the type mentioned above, which is known from the prior art. The planetary gearwheel 102 is mounted to rotate on a planetary shaft or planetary bolt 108 by means of a first bearing 104 and a second bearing 106. The planetary shaft 108 is fixed in a planetary carrier 110,

In the axial direction the inner rings of the first bearing 104 and the second bearing 106 are clamped between the planetary carrier 110 and the planetary shaft 108. However, since the first bearing 104 and the second bearing 106 are cylindrical roller bearings, a certain bearing play 112 is needed in the axial direction. To ensure this, a spacer 114 is positioned between the inner rings of the first bearing 104 and the second bearing 106.

The use of a spacer 114 not only gives rise to additional costs, but also to problems during assembly. The transmission is usually assembled by first inserting the first bearing 104 and the second bearing 106 from opposite sides into the planetary gearwheel 102. Once the planetary gearwheel 102 with the first bearing 104 and the second bearing 106 has been positioned in the planetary carrier 110, the planetary shaft 108 is inserted through an opening 116 in the planetary carrier 110. If a spacer 114 is used, this too has to be positioned before the insertion of the planetary shaft 108. However, no guiding of the spacer 114 in the radial direction takes place either by the planetary gearwheel 102 or by the first bearing 104 or the second bearing 106. This makes it necessary to adopt additional measures in order to position the spacer 114.

Furthermore, it is not possible to correct the bearing play 112 after the planetary shaft 108 has been inserted into the planetary carrier 110. For this, the spacer 114 would have to be taken out and replaced by a spacer 114 of different width.

From the document US 2012/0003096 A1 the mounting of a planetary gearwheel by means of two bearings without the use of a spacer between the inner rings of the two bearings is known. The planetary shaft is cylindrical. Thus, there is no guiding of the two bearings by the planetary shaft in the axial direction. Instead, the planetary carrier has two surfaces extending circumferentially and perpendicularly to the rotational axis. Against these surfaces a respective inner ring of each bearing can be supported to prevent displacement in the axial direction. Thus, the bearing play is defined by the two surfaces.

In the solution described the planetary carrier must be made in such manner that the distance between the two surfaces against which the inner rings can be supported is within narrow tolerance limits predetermined by the bearing play to be produced. In practice this would give rise to considerable problems. Moreover, the rigidity of the planetary carrier against the loading of one of the two lateral halves in the axial direction is only very insufficient. Furthermore, in the form illustrated in the document US 2012/0003096 A1 the transmission could not be assembled, since the planetary carrier is apparently made in one piece. However, a two-piece planetary carrier would exacerbate the above-describes tolerance problem.

### SUMMARY OF THE INVENTION

The purpose of the present invention is to indicate a planetary transmission which is exempt from the disadvantages of the prior art described above.

According to the invention, this objective is achieved by a planetary transmission having the characteristics and advantageous developments as described below.

The planetary transmission comprises a planetary gearwheel which is mounted to rotate on a planetary shaft by means of at least one first bearing and at least one second bearing. Preferably, the planetary gearwheel is mounted to rotate about just one rotational axis.

In what follows, a means for supporting a first element in a second element against displacement in a particular direction, refers to a means for the interlocked fixing of the first element onto the second element against displacement in the direction. Correspondingly, the supporting of a first element against a second element against displacement of the first element in a direction, means that the first element is fixed on the second element in such manner as to prevent any translational movement of the first element in the direction.

The first bearing is designed such that it can support the planetary gearwheel at least against any displacement in a first axial direction, such as toward the rotor of a wind turbine. Displacement means a translational movement. Thus, a displacement in an axial direction means a translational movement parallel to the rotational axis of the planetary gearwheel.

Depending on the embodiment, the first bearing supports the planetary gearwheel on the planetary carrier and/or on the planetary shaft. This means the following: if a force acts on the planetary gearwheel which would move it in the axial direction, the first bearing counters that force so that the axial position of the planetary gearwheel remains unchanged. Thus, the planetary gearwheel is supported according to the situation, depending on the axial forces acting on the planetary gearwheel.

Analogously, the second bearing can support the planetary gearwheel at least against a displacement in a second axial direction opposite to the first direction, such as toward the generator of a wing turbine. The first and second directions are so orientated that they extend away from one another. Correspondingly, displacement of the inner ring of the first bearing in the first direction and/or of the inner ring of the second bearing in the second direction causes the distance between the two inner rings to increase. As viewed from the second bearing, the first bearing is in the first direction, whereas as viewed from the first bearing, the second bearing is in the second direction.

Means for supporting the inner rings of the two bearings serve to position the first bearing and the second bearing, and therefore also the planetary gearwheel, in the axial direction. At least one means serves to support the inner ring of the first bearing on the planetary carrier against any displacement of the inner ring in the first direction. As means for supporting the inner ring of the first bearing, the planetary carrier preferably comprises a circumferential surface preferably perpendicular to the rotational axis of the planetary gearwheel. This surface describes a circular ring perpendicular to the rotational axis. If the inner ring of the first bearing is in contact with the surface, that prevents any displacement in the first direction. Contact is either direct or via an element, such as an annular spacer, positioned between the inner ring of the first bearing and the surface.

Analogously, the planetary transmission comprises at least one means for supporting an inner ring of the second bearing on the planetary shaft against any displacement of the inner ring in the second direction. Such means prevents any displacement of the inner ring of the second bearing in the second direction.

As means for supporting the inner ring of the second bearing, the planetary shaft preferably comprises a step, i.e. a circumferential surface extending perpendicularly to the rotational axis of the planetary gearwheel, which describes a circular ring perpendicular to the rotational axis of the planetary gearwheel. This surface is designed such that it can make contact with the inner ring of the second bearing. The contact is either direct or via a further element, which can for example be in the form of an annular spacer.

Since the first bearing can support the planetary gearwheel against displacement in the first direction and the second bearing can support it against displacement in the second direction, the bearing play between the two bearings is defined by the means for supporting the inner ring of the first bearing and the means for supporting the inner ring of the second bearing. Since the inner ring of the first bearing is supported on the planetary carrier and the inner ring of the second bearing on the planetary shaft, the position of the planetary shaft relative to the planetary carrier has to be fixed as a function of the bearing play desired. For this, the planetary shaft is supported on the planetary carrier against any displacement in the first direction.

As supporting means, preferably both the planetary shaft and the planetary carrier each comprise a surface extending circumferentially and perpendicularly to the rotational axis of the planetary gearwheel. The two surfaces are directed so as to enable an interlocking contact. Preferably, the surfaces are opposite one another. The two surfaces contact one another either directly or via a further element, which is preferably an annular spacer. According to the invention, the further element is not the first bearing and/or the second bearing, in particular not the inner ring of the first bearing and/or the inner ring of the second bearing. According to the invention, the first bearing and/or the second bearing, or the inner rings of the first bearing and/or the second bearing, are not designed to be means for supporting the planetary shaft on the planetary carrier, Instead, the at least one means for supporting the planetary shaft on the planetary carrier is arranged such that the first bearing and the second bearing cannot be in a load path between the planetary shaft and the planetary carrier, in particular not in a load path for supporting the planetary shaft on the planetary carrier. This means that no force flow that can be produced by virtue of the supporting of the planetary shaft on the planetary carrier passes through the first bearing, in particular the inner ring of the first bearing, and/or the second bearing, in particular the inner ring of the second bearing. A force flow that can be produced by supporting the planetary shaft on the planetary carrier must pass between the planetary shaft and the planetary carrier circumventing the first bearing and the second bearing. The first bearing and the second bearing do not transmit any forces between the planetary shaft and the planetary carrier, in particular no forces that can be produced by supporting the planetary shaft on the planetary carrier.

This can be ensured in that no means for supporting the planetary shaft on the planetary carrier are arranged between the first bearing and the second bearing, or are arranged in such manner that a load path between the first bearing, in particular its inner ring, and the second bearing, in particular its inner ring, passes by way of a means for supporting the planetary shaft on the planetary carrier. In particular, no load path extends in the axial direction between the first bearing and the second bearing via a means for supporting the planetary shaft on the planetary carrier. Instead, the means for supporting the planetary shaft on the planetary carrier are arranged outside the space between the first and second bearings, in particular outside the space between the inner rings of the first and second bearings.

In a preferred further development of the invention the planetary carrier has an opening through which the planetary shaft can be inserted into the planetary carrier. This is used when assembling the planetary transmission. The opening is preferably through-going and has a circular basic shape. Opposite the opening, the planetary carrier has a recess also with a circular basic shape, into which the planetary shaft can be inserted.

Insertion into the planetary carrier (110) takes place essentially in the first direction, i.e. by moving the planetary shaft in the first direction.

Preferably, the planetary transmission comprises means for fixing the planetary shaft at least against any axial displacement in the second direction. These means can in particular be the opening and the recess. Preferably, in this case at the opening and/or at the recess the planetary carrier and the planetary shaft are joined by a press fit, in particular a shrink fit in which the planetary carrier is heated and then shrunk onto the planetary shaft.

The press or shrink fit also fixes the planetary shaft against any displacement in the first direction. Against that background, the means for supporting the planetary shaft on the planetary carrier against any displacement of the planetary shaft in the first direction also serve the purpose of holding the planetary shaft after its insertion into the planetary carrier, in a correct position until the press fit or shrink fit has been formed.

Particularly advantageous for assembly is an embodiment of the planetary transmission having an at least two-piece planetary shaft. In this case a first part is connected detachably to a second part, for example screwed thereto. The first bearing and the second bearing are fitted onto the first part, i.e. the inner rings of the first and second bearings are fixed onto the first part. At least one portion of the second part is designed as a means for supporting the planetary shaft on the planetary carrier. This makes it possible for the second part to be detached from the first part while the first part is in the planetary carrier.

For assembly, as already described above the planetary shaft is inserted into the planetary carrier. If now an unacceptable bearing play exists, the second part can be taken off in order to allow a suitable spacer to be inserted.

### BRIEF DESCRIPTION OF THE DRAWINGS

Preferred example embodiments of the present invention are described below with reference to the attached figures. In these the same indexes denote the same or functionally similar components, so that in particular the description of a component in one figure can be referred to for determining the function of a component with the same index in another figure, and vice-versa.

The figures show:

FIG. 1: An axial fixing method of a planetary mounting, known from the prior art;

FIG. 2: A planetary mounting according to the invention, with support of the planetary shaft on the planetary carrier on the generator side;

FIG. 3: A planetary mounting according to the invention, with support of the planetary shaft on the planetary carrier at the bottom of the recess on the generator side; and

FIG. 4: A planetary mounting according to the invention, with support of the planetary shaft on the planetary carrier at the edge of the recess on the rotor side.

### DETAILED DESCRIPTION OF THE PREFERRED EMBODIMENTS

FIGS. 1 to 4 show a planetary shaft 108 which is fixed in an opening 116 on the generator side and in a bore 118 on the rotor side. A planetary gearwheel 102 is mounted to rotate on the planetary shaft 108 by means of a first bearing 104 and a second bearing 106. Two locking rings 120 or alternatively a step 122 in the planetary gearwheel 102 (FIGS. 1 to 4 show both alternatives) prevent any displacement of the planetary gearwheel 102 relative to the first bearing in a first direction 124, and any displacement of the planetary gearwheel 102 relative to the second bearing 106 in a second direction 126.

A displacement of the first bearing 104 relative to the planetary carrier 110 and/or the planetary shaft 108 in the first direction 124 is prevented by direct contact of the inner ring of the first bearing 104 with the planetary carrier 110. Here, the contact surface 128 extends perpendicularly to the rotational axis of the planetary gearwheel 102. Analogously, a step 130 in the planetary shaft 108 prevents any displacement of the second bearing 106 in the second direction 126 by virtue of direct contact with the inner ring of the second bearing 106. The annular spacer 114 is located between the inner rings of the first bearing 104 and the second bearing 106.

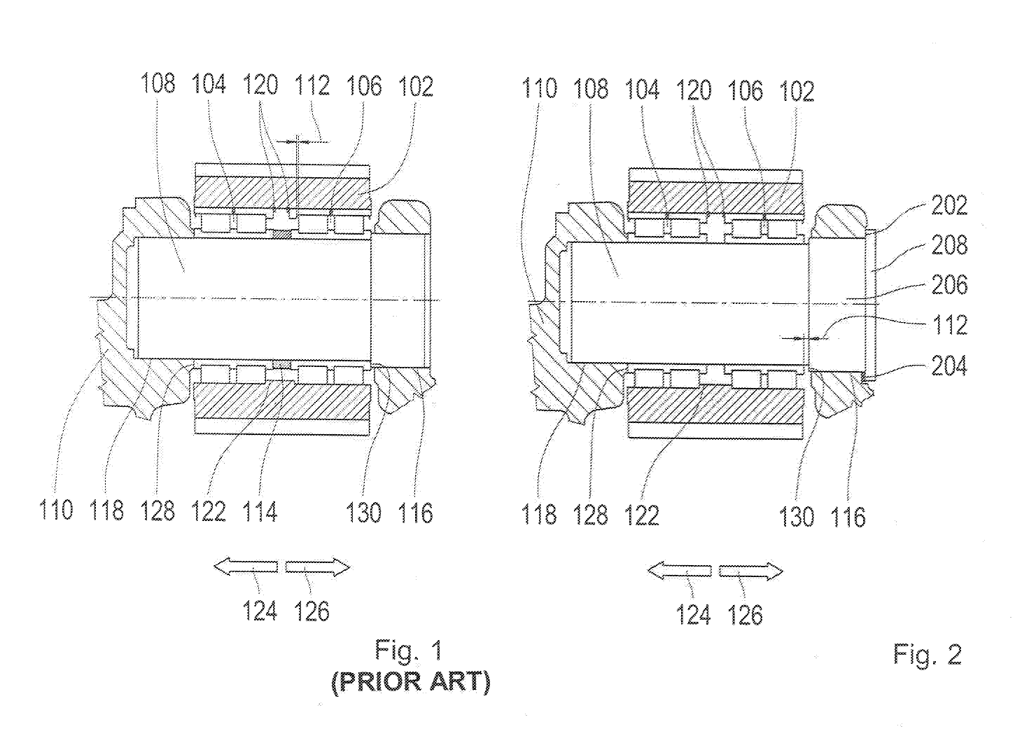

In the embodiments shown in FIGS. 2 to 4 there is no spacer 114 between the first bearing 104 and the second bearing 106. Instead, in each case a pair of functional surfaces 202 prevents a displacement of the planetary shaft 108 toward the planetary carrier 110 in the first direction 124. The pair of functional surfaces 202 consists, respectively, of a surface of the planetary carrier 110 and a surface of the planetary shaft 108, which are in direct contact with one another or, alternatively, in contact via a spacer 204 (in FIGS. 2 to 4 both alternatives are shown in each case). The surface of the planetary carrier 110 that belongs to the functional surface pair 202 faces toward the second direction 216, while the surface of the planetary shaft 108 that belongs to the functional surface pair 202 faces toward the first direction 124.

In an example embodiment according to FIG. 2, the pair of functional surfaces 202 and the spacer 204 (shown in the lower part of the figure) are located on the generator side outside the planetary carrier. This makes possible a two-piece design of the planetary shaft 108, with a first part 206 and a second part 208. While the first part 206 is in the planetary carrier 110, the second part 208 can be removed in order to adapt the spacer 204 according to the bearing play 112 desired.

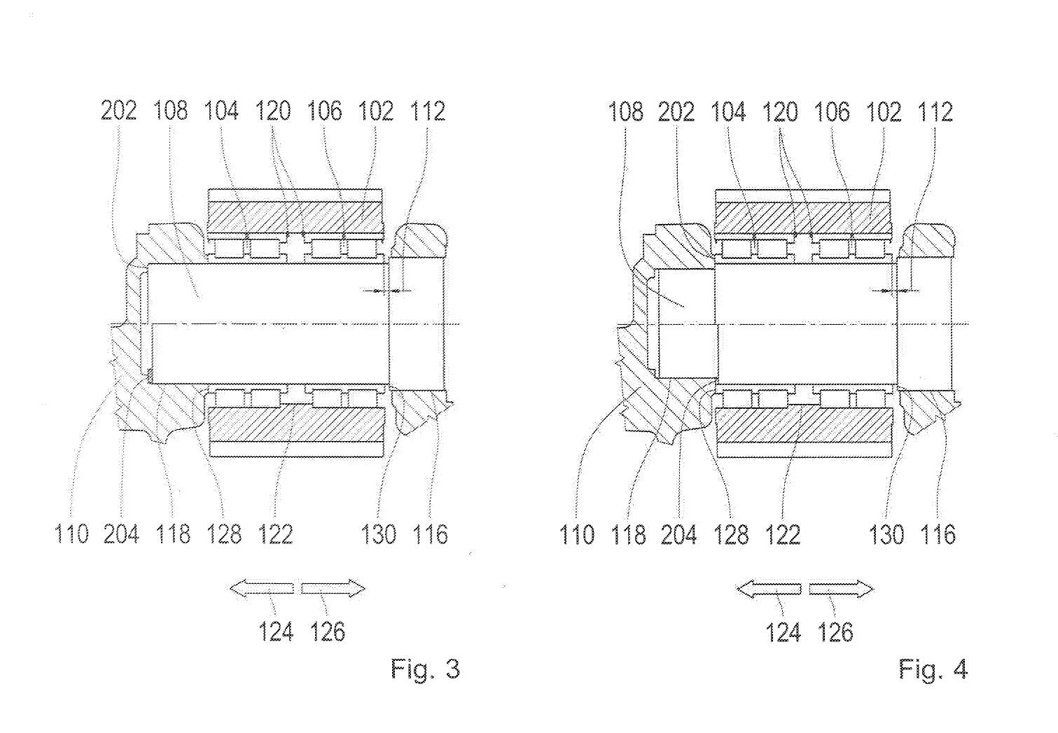

Alternatively, as shown in FIG. 3, the functional surface pair 202 and the spacer 204 (shown in the lower part) can be arranged within a bore 118 in the planetary carrier 110 on the generator side. In this case the bottom of the bore 118 has a surface extending radially which—directly, or via the spacer 204—comes into contact with the basic surface of the planetary shaft 108 and thus supports the planetary shaft against axial displacement in the first direction 124.

As shown in FIG. 4, the functional surface pair 202 can moreover be formed by a further step in the planetary shaft 108 and a surface of the planetary carrier 110 that extends in the radial direction. This surface not only supports the planetary shaft 108—directly, or via the spacer 204 (shown in the lower part)—but also the inner ring of the first bearing 104 against axial displacement in the first direction 124.

### INDEXES

102 Planetary gearwheel

104 First bearing

106 Second bearing

108 Planetary shaft

110 Planetary carrier

112 Bearing play

114 Spacer

116 Opening

118 Bore

120 Locking rings

122 Step

124 First direction

126 Second direction

128 Contact surface

130 Step

202 Pair of functional surfaces

204 Spacer

206 First part

208 Second part

1-7. (canceled)

8. A planetary transmission comprising:
at least one planetary gearwheel (102);
at least one planetary shaft (108);
at least one planetary carrier(110);
the planetary gearwheel (102) being mounted for rotation on the planetary shaft (108) by at least a first bearing (104) and at least a second bearing (106) so that the first bearing (104) supporting the planetary gearwheel (102), at least against displacement in a first axial direction (124), and the second bearing (106) supporting the planetary gearwheel (102), at least against displacement in a second axial direction (126), opposite to the first direction (124);
at least one first means (128) for supporting an inner ring of the first bearing (104), on the planetary carrier (110), against displacement of the inner ring of the first bearing in the first direction (124);
at least one second means (130) for supporting an inner ring of the second bearing (106), on the planetary shaft (108), against displacement of the inner ring of the second bearing in the second direction (126);
at least one third means (202, 204) for supporting the planetary shaft (108) on the planetary carrier (110) against displacement of the planetary shaft (108) in the first direction (124); and
the third means (202, 204), for supporting the planetary shaft (108) on the planetary carrier (110), being arranged so that the first bearing (104) and the second bearing (106) cannot be in a load path between the planetary shaft (108) and the planetary carrier (110),

9. The planetary transmission according to claim 8, wherein the planetary carrier (110) has an opening (116) through which the planetary shaft (108) is insertable into the planetary carrier (110).

10. The planetary transmission according to claim 8, wherein the planetary shaft (108) is inserted into the planetary carrier (110) in the first direction (124).

11. The planetary transmission according to claim 8, wherein at least one spacer (204) serves as the third means for supporting the planetary shaft (108) on the planetary carrier (110).

12. The planetary transmission according to claim 8, wherein the planetary shaft (108) comprises at least a first part (206) and a second part (208) such that:
the first part (206) and the second part (208) are detachably connected with one another,
the first bearing (104) and the second bearing (106) are fitted onto the first part (206), and
at least a portion of the second part (208) supports the planetary shaft (108) on the planetary carrier (110).

13. The planetary transmission according to claim 12, wherein the planetary carrier (110) and the planetary shaft (108) are designed so that the second part (208) is removable from the first part (206) while the first part (206) is in the planetary carrier (110).

14. A transmission for a wind turbine, the transmission being a planetary transmission comprising:
at least one planetary gearwheel (102);
at least one planetary shaft (108);
at least one planetary carrier(110);
the planetary gearwheel (102) being mounted for rotation on the planetary shaft (108) by at least a first bearing (104) and at least a second bearing (106), such that the first bearing (104) supporting the planetary gearwheel (102), at least against displacement in a first axial direction (124), and the second bearing (106) supporting the planetary gearwheel (102), at least against displacement in a second axial direction (126) opposite to the first direction (124);
at least one first means (128) for supporting an inner ring of the first bearing (104), on the planetary carrier (110), against displacement of the inner ring of the first bearing in the first direction (124);
at least one second means (130) for supporting an inner ring of the second bearing (106), on the planetary shaft (108), against displacement of the inner ring of the second bearing in the second direction (126);
at least one third means (202, 204) for supporting the planetary shaft (108), on the planetary carrier (110), against displacement of the planetary shaft (108) in the first direction (124); and
the third means (202, 204) for supporting the planetary shaft (108), on the planetary carrier (110), being arranged so that the first bearing (104) and the second bearing (106) cannot be in a load path between the planetary shaft (108) and the planetary carrier (110).

15. A planetary transmission comprising:
at least one planetary gearwheel;
at least one planetary shaft;
at least one planetary carrier;
the planetary gearwheel being mounted for rotation on the planetary shaft by at least a first bearing and at least a second bearing so that the first bearing supporting the planetary gearwheel, at least against displacement in a first axial direction, and the second bearing supporting the planetary gearwheel, at least against displacement in a second axial direction, opposite to the first direction;
at least one first mechanism for supporting an inner ring of the first bearing, on the planetary carrier, against displacement of the inner ring of the first bearing in the first direction;
at least one second mechanism for supporting an inner ring of the second bearing, on the planetary shaft, against displacement of the inner ring of the second bearing in the second direction;
at least one third mechanism for supporting the planetary shaft on the planetary carrier against displacement of the planetary shaft in the first direction; and
the third mechanism, for supporting the planetary shaft on the planetary carrier, being arranged so that the first bearing and the second bearing cannot be in a load path between the planetary shaft and the planetary carrier.
